(19) United States
(12) Patent Application Publication
(10) Pub. No.: US 2014/0379456 A1
(43) Pub. Date: Dec. 25, 2014

(54) METHODS AND SYSTEMS FOR DETERMINING IMPACT OF AN ADVERTISEMENT

(71) Applicant: United Video Properties, Inc., Santa Clara, CA (US)

(72) Inventor: Ashleigh A. Miller, Denver, CO (US)

(73) Assignee: United Video Properties, Inc., Santa Clara, CA (US)

(21) Appl. No.: 13/925,645

(22) Filed: Jun. 24, 2013

(51) Int. Cl. G06Q 30/02

(52) U.S. Cl. CPC G06Q 30/0242
USPC 705/14.41

(57) ABSTRACT

Methods and systems are provided for determining the impact of an advertisement based on the number of times keywords are used by a user before and after the user viewed the advertisement. In some embodiments, control circuitry receives first communication data before the media asset is viewed and determines a number of times keywords are included in the first communication data. The control circuitry further receives second communication data after the media asset is viewed and determines a number of times keywords are included in the second communication data. The control circuitry then determines the impact of the media asset on the user of a user device based on the difference in the number of times the keywords are included in the first and the second communication data.

### BACKGROUND

Measuring effectiveness or impact of an advertisement on consumers is important to a company because it allows companies to make strategic investments in key marketing programs. In part, measuring impact of an advertisement involves determining whether an advertisement has reached the right audience, got noticed, and drove behavioral change.

### SUMMARY

This disclosure discusses methods and systems for measuring impact of an advertisement on a user by measuring number of times a plurality of keywords are used, in user communication, before and after the user viewed the advertisement. Impact of an advertisement may include change, due to the advertisement, in a user's behavior, activities, communication, financial transactions, etc. Keywords may be associated with different products included in the advertisement. User communication may include a regular everyday conversation, communication via email, an instant messaging service (e.g., chat, tweets, text messages, comments on social network, etc.), a voice connection (e.g., a phone call, voice over IP (VOIP)), etc.

For example, the methods and systems in this disclosure may determine whether a user is talking more or less, such as in everyday conversation, on social media networks, tweets, etc. about products associated with an advertisement about a brand of soda after watching the advertisement. The system may determine whether the user bought the brand of soda after watching the advertisement. The system may also determine whether the user is discussing and/or purchasing any other products, such as background music, famous actor, clothes of the famous actor, etc. included in the advertisement.

There may be no change in user communication because the user is generally interested in that brand of soda, or there may be a large change because the user is affected by the advertisement about that brand of soda. This data, associated with the impact of an advertisement, may be important for a company that wants to capture new customers and expand their market share. The companies may want to spend more resources on identifying and getting new customers than on retaining existing customers. Additionally, if the first advertisement is ineffective in attracting a consumer's attention, then the methods and systems of this disclosure may automatically determine a second advertisement for the same or different product.

In some embodiments, control circuitry retrieves first communication data corresponding to a first communication that took place before a media asset is viewed by a user, where the user was involved in the first communication. The control circuitry further retrieves, from a storage device, a keyword associated with the media asset; compares the first communication data with the keyword; and determines a number of times the keyword was included in the first communication data. Once the user viewed the media asset, the control circuitry further retrieves second communication data corresponding to a second communication that took place after the user viewed the media asset. The control circuitry then compares the second communication data with the keyword; and determines a number of times the keyword was included in the second communication data. With this information the control circuitry may determine an impact of the media asset on the user based on the number of times the keyword was included within the first communication data and the number of times the keyword was included within the second communication data.

In some embodiments, determining the impact may include determining a value associated with change between the number of times the keyword was included within the first communication data and the number of times the keyword was included within the second communication data. This value may be added to a previously determined value associated with another keyword. The another keyword may also be associated with the media asset.

In some embodiments, the control circuitry may identify a weight associated with the keyword, and may determine a first index based on the weight and the number of times the keyword was included within the first communication data. The control circuitry may determine a second index based on the weight and the number of times the keyword was included within the second communication data. The impact of the media asset on the user of the user device may be based on the first index and the second index.

In some embodiments, determining the impact includes determining a value associated with change between the second index and the first index. This value may be added to a previously determined value associated with another keyword. The another keyword may also be associated with the media asset.

In some embodiments, the control circuitry may determine a product associated with the keyword, and may further determine a second media asset associated and/or not associated with the product. In some embodiments, the control circuitry may compare the impact of the first media asset to a threshold. When the impact exceeds the threshold, the control circuitry may select a second media asset that is unrelated to the first media asset. When the impact is lower than the threshold, the control circuitry may select the second media asset that is related to the first media asset.

In some embodiments, when the impact is lower than the threshold, the control circuitry may determine a first number of times the first media asset was viewed by the user; and display the second media asset for a second number of times based on the first number of times the first media asset was viewed by the user.

In some embodiments, when the impact is lower than the threshold, the control circuitry may determine a first user device on which the user viewed the first media asset; and generate for display the second media asset on a second user device based on the first user device on which the user viewed the first media asset.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative display screen that may be used to provide media guidance application listings and other media guidance information in accordance with an embodiment;

FIG. 2 depicts another illustrative display screen that may be used to provide media guidance application listings in accordance with an embodiment;

FIG. 3 depicts a block diagram of an illustrative user equipment device in accordance with an embodiment;

FIG. 4 depicts a block diagram of an illustrative interactive media system in accordance with an embodiment;

FIG. 5 depicts a block diagram of an illustrative media asset impact monitoring system in accordance with an embodiment;

FIG. 6 depicts an illustrative display screen showing a number of times a plurality of keywords are included in a user's communication before and after a media asset is viewed in accordance with an embodiment;

FIG. 7 depicts an illustrative display screen showing the impact of a media asset on a user of a user device determined by a media asset impact monitoring system in accordance with an embodiment;

FIG. 8 depicts an illustrative process implemented by a media asset impact monitoring system in accordance with an embodiment;

FIG. 9 depicts an illustrative process implemented by a media asset impact monitoring system for automatically determining impact of a media asset in accordance with an embodiment;

FIG. 10 depicts an illustrative process implemented by a media asset impact monitoring system for automatically determining user interest in accordance with an embodiment;

FIG. 11 depicts an illustrative process implemented by a media asset impact monitoring system for automatically determining impact of a media asset in accordance with an embodiment; and

FIG. 12 depicts an illustrative process implemented by a media asset impact monitoring system for automatically taking a preferred action in accordance with an embodiment.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, advertisements, as well as pay-per-view programs, on-demand programs (as in video-on-demand (VOD) systems), program segments, Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), keywords associated with a media asset, on-demand information, blogs, websites, and any other type of guidance data that is helpful for a user to navigate among and locate desired content selections.

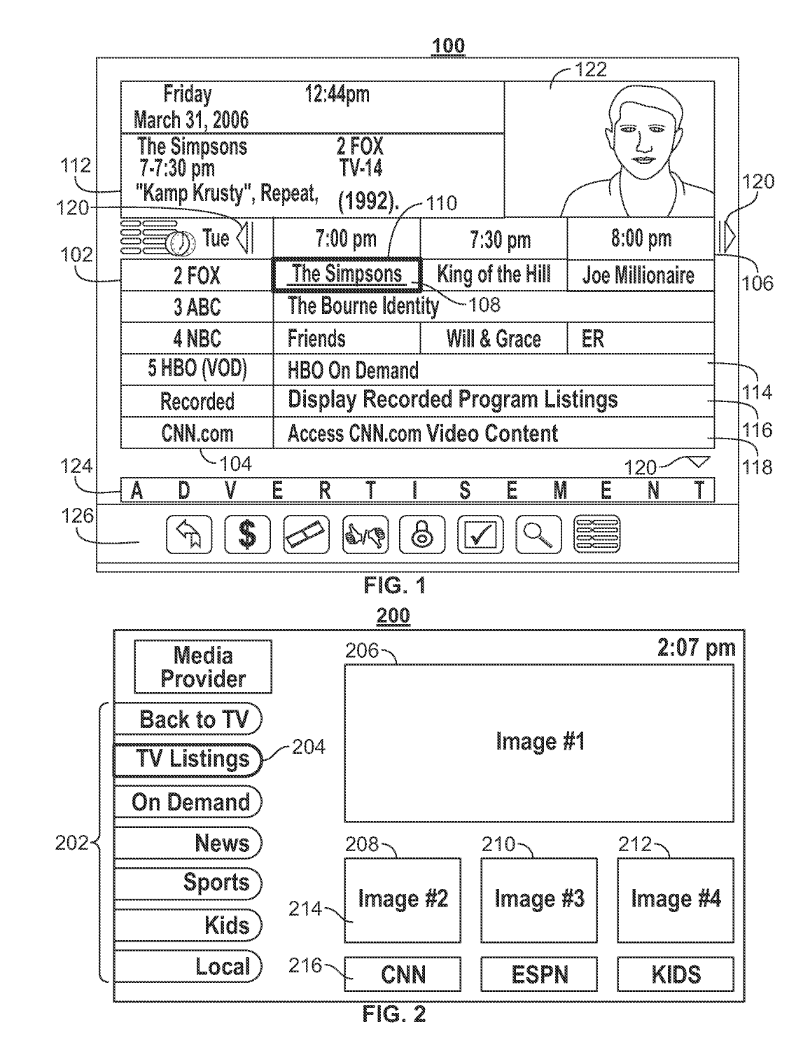

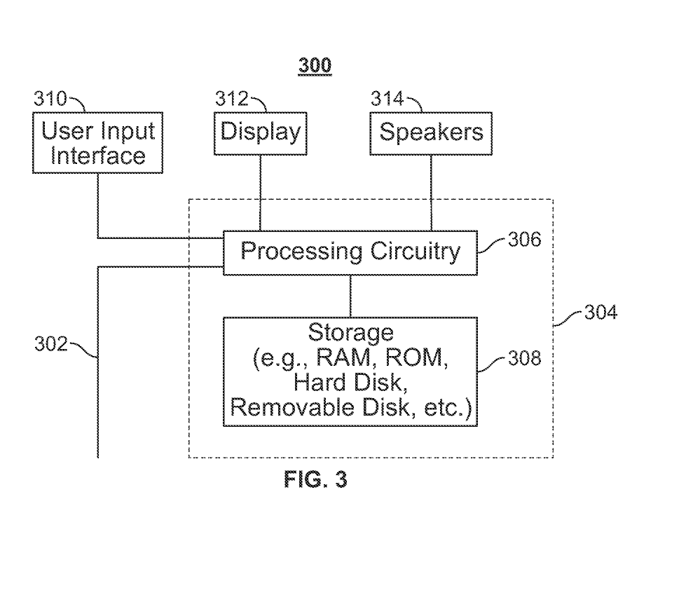

FIGS. 1-2 show illustrative display screens that may be used to provide media guidance data. The display screens shown in FIGS. 1-2 and 6-7 may be implemented on any suitable user equipment device or platform. While the displays of FIGS. 1-2 and 6-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Products may include traditional products available in brick and mortar stores, products available on Internet, services, brand, a commodity, trademarks associated with a company, company, media assets, software, etc. In some embodiments, products may also include famous personalities, activities, ideas, buildings, countries, languages, commercial and/or non-commercial entities, etc.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may be for products.

Advertisement 124 may also be associated with product placement. Advertisement 124 may be selectable and provide further information about content, provide information about a product, enable purchasing of content, a product, provide content relating to the advertisement, etc. Advertisement 124 may be targeted based on a user's profile/preferences, monitored user activity, the type of display provided, or on other suitable targeted advertisement bases. Advertisement 124 may also be a part of video stream of a media asset. For example, advertisement 124 may be a commercial in a television program or in an internet video.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

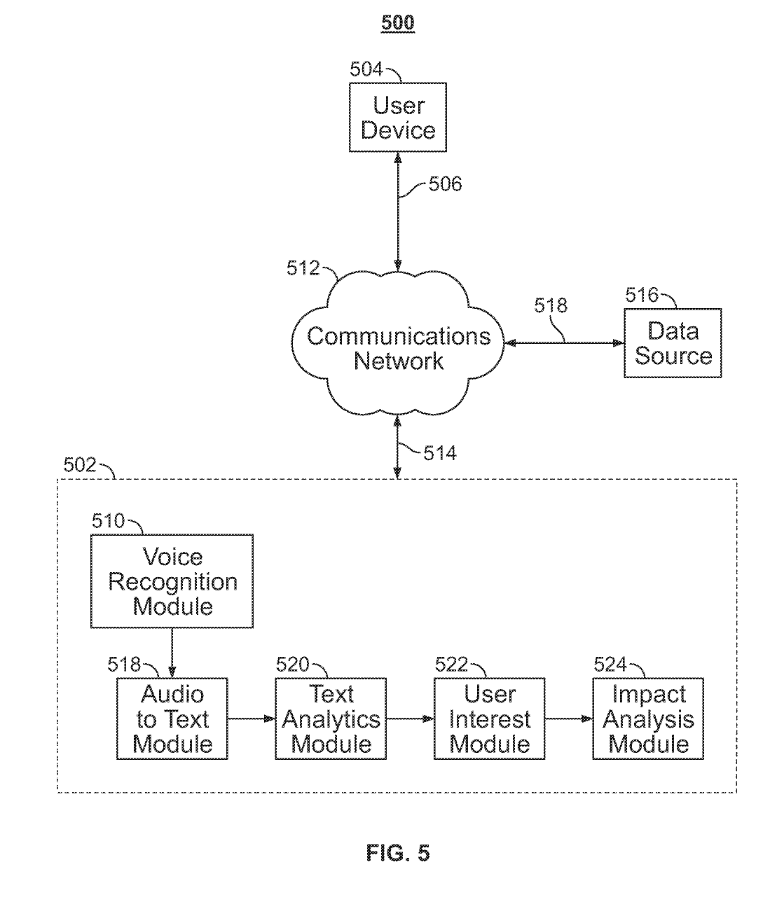

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. User profile may also include geographical, ethnical, personal, financial, demographical information related to a user. User profile may further include the real-time location of the user which can be tracked using the global positioning device (gps) present in any user device. User profile may also include user likes and dislikes associated with type of different products. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

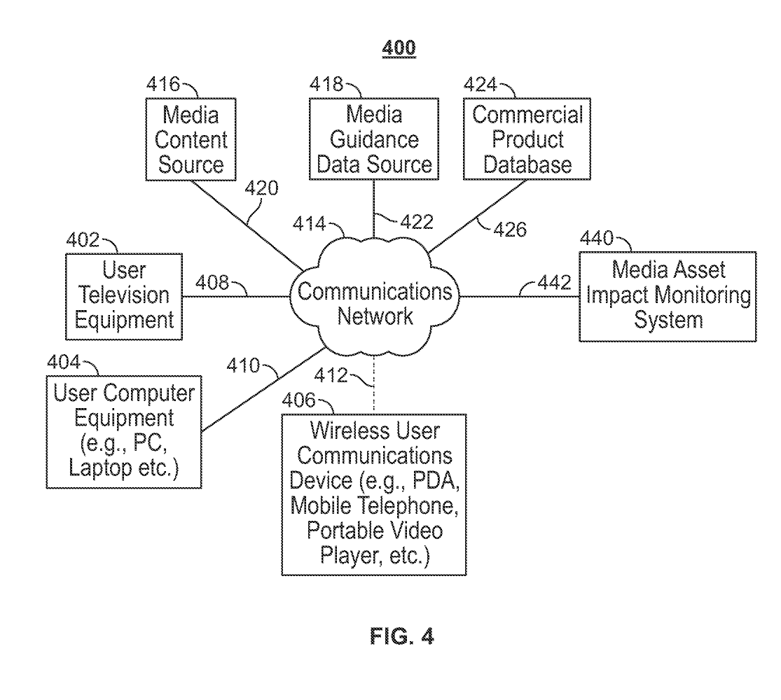

Users may access content and the media guidance application (and its display screens described above and below) from one or more of their user equipment devices. FIG. 3 shows a generalized embodiment of illustrative user equipment device 300. More specific embodiments of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some embodiments, any action performed by control circuitry 304 may be based on instructions received from the media guidance application.

In client-server based embodiments, control circuitry 304 may include communications circuitry suitable for communicating with a guidance application server, media asset impact monitoring system, or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry, voice recognition, and tuning circuitry, such as one or more analog tuners, one or more MPEG-2 decoders or other digital decoding circuitry, high-definition tuners, or any other suitable tuning, video, or audio circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, voice recognition, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. Speakers 314 may include microphones that may pick up speech and send it to control circuitry 304 for voice recognition. In some embodiments, the audio may be distributed to a receiver (not shown), which processes and outputs the audio via speakers 314. Voice recognition and analysis may be done by processing circuitry 306 or may be analyzed by a dedicated voice recognition module.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may incorporate a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, modifications made on one user equipment device can modify the guidance experience on another user equipment device, regardless of whether they are the same or a different type of user equipment device. In addition, the modifications made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416, media guidance data source 418, commercial product database 424, and media asset impact monitoring system 440 coupled to communications network 414 via communication paths 420, 422, 426, and 442 respectively. Paths 420, 422, 426, and 442 are substantially similar to any of the communication paths described above in relation to paths 408, 410, and 412. Communications with the content source 416, media guidance data source 418, commercial product database 424, and media asset impact monitoring system 440 may be exchanged over one or more communications paths, but are shown as a single path in FIG. 4 to avoid overcomplicating the drawing. In addition, there may be more than one of each of content source 416, media guidance data source 418, commercial product database 424, and media asset impact monitoring system 440 but only one of each is shown in FIG. 4 to avoid overcomplicating the drawing. The different types of each of these sources and servers are discussed below.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc.

Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety. Content source 416 may include social network server that may be used to store information, for example user's interest on social network, related to social media.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Commercial product database 424 provides data related to various products to media impact monitoring system 440, which in turn use this data to determine impact of an advertisement. The data may include plurality of keywords, phrases, abbreviations, shorthand forms of keywords, metadata, etc. For simplicity this data will be referred as “keywords”. For example, data related to a mobile phone may include keywords such as specific brand names, smartphone, etc. The keywords may identify certain characteristics that may or may not be specific to a product or may be common for many different products. For example, keywords may include a company's name, which may be common to other products from the same company. Keywords related to products may also include catch phrases that are associated with a product, for example “beamer” may refer to a BMW car. BMW is a trademark owned by BMW AG.

Commercial product database 424 may include keywords related to a media asset, such as an advertisement, associated with a product. Keywords may be used to describe the media asset, its content, products included in the media asset. For example, keywords for an advertisement for a famous soda with a famous actor may include keywords that could be used to identify the soda, famous actor, clothes the famous actor is wearing, playback song of the advertisement, any products the famous actor is using, any landmarks shown in the advertisement, content of the advertisement, etc. Keywords may identify content of the advertisement at a scene level. Each scene may show a different product. In one scene, an actor may be driving a certain car or wearing a particular type of clothing. In another scene, the actor may be wearing different clothing, or another actor may be in the shot with other items that may be promoted (e.g., a cell phone, sun glasses, etc.). By providing keywords at scene level, more descriptive information about the advertisement can be provided in a more temporally associated way. Keywords may also include links to other advertisements. Commercial product database 424 may be a dynamic database that may be updated periodically as new products and the information related to them is available.

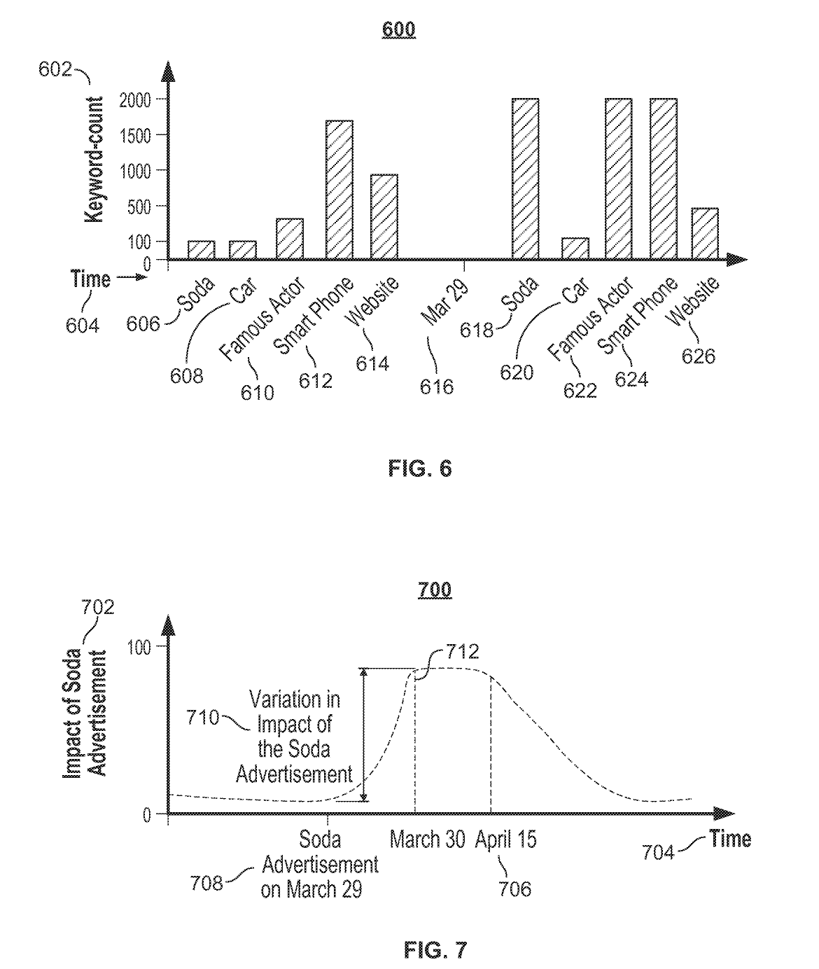

Media asset impact monitoring system 440 is a system for monitoring the impact of an advertisement on a user of a user device before and after the advertisement is viewed by the user. The modules of this system are described in detail in relation to FIG. 5. In some embodiments, media impact monitoring system 440 is connected to a vendor server that may be associated with a specific vendor. The vendor server may allow a vendor to interact with media asset impact monitoring system 440 in multiple ways, such as requesting impact data, providing vendor preferences, providing keywords for various advertisements that the vendor may be interested in monitoring, etc.

Although communications between content source 416, media guidance data source 418, commercial product database 424, and media asset impact monitoring system 440 with user equipment devices 402, 404, and 406 are shown as through communications network 414, in some embodiments, content source 416, media guidance data source 418, commercial product database 424, and media asset impact monitoring system 440 may communicate directly with user equipment devices 402, 404, and 406 via communication paths (not shown) such as those described above in connection with paths 408, 410, and 412.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Application Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

The elements depicted in FIG. 4 may be combined, rearranged, and/or deleted without departing from the scope of the disclosure. For example, in some embodiments, media impact monitoring system 440 may be incorporated into any or all of the different modules of FIG. 4, such as user equipment devices 402, 404 and/or 406, media content source 416, media guidance data source 418, and commercial product database 424. In some embodiments, media asset impact monitoring system 440 may be a standalone system. If desired, content source 416, media guidance data source 418, and commercial product database 424 may be integrated as one source device.

FIG. 5 is a block diagram of illustrative system 500 including media asset impact monitoring system 502 for determining impact of a media asset, such as an advertisement, on a user of user device 504. The impact may be based on monitoring keywords included in the user's communication before and after the advertisement is viewed by the user. System 500 includes user device 504, data source 516 and media impact monitoring system 502 each connected to communication network 512 using communication paths 506, 518 and 514 respectively. User device 504 may be substantially similar to user equipment device 300 described in FIG. 3. Communication network 512 may be substantially similar to the network 414 described in relations to FIG. 4.

Data source 516 may be substantially similar to any or all of the data sources, such as, media content source 416, media guidance data source 418, and commercial product database 424 described in relation to FIG. 4. Communication paths 506, 514, and 518 can be substantially similar to any of the communication paths 408, 410, 412, 420, 422, 426, and 442 discussed in relation to FIG. 4. Media asset impact monitoring system 502 may include voice recognition module 510, audio to text module 518, text analytics module 520, user interest module 522, and impact analysis module 524.

In some embodiments, user device 504 may be registered with media asset impact monitoring system 502 to allow the system 502 to monitor any user activity, such as, Internet browsing, gaming, communication with other devices, and/or people, throughout a day.

Media asset impact monitoring system 502 monitors communication of a user to determine the impact of an advertisement. System 502 may receive user communication data either through voice recognition module 510 or through text analytics module 520. A user may communicate with a user contact, over communications network 514, via their respective user devices. In some embodiments, a user device may store user communication data and transfer the communication data to media asset impact monitoring system 502 either continuously or periodically in batches. The user device may also cache user communication data in case the connection between the user device and media asset impact monitoring system 502 is interrupted.

The user contact includes user's friends, family members, co-workers, casual acquaintances, sales people, social media followers, merchants, customer service agents, etc. In some embodiments, the user contact includes a person with whom the user is communicating for the first time. The user contact may also be a machine, such as, the user's cell phone, gaming console, television equipment, etc.

A user may communicate with a user contact using various sources of communication, such as, email, an instant messaging service (e.g., chat, tweets, comments on social network, etc.), a voice connection (e.g., a phone call or voice over IP (VOIP)), etc. Communication data may include audio and/or text component of the user's communication with another user (e.g., any of the user contacts or friends) using any of the sources of communication discussed above. The audio component of the communication data may include audio of the user's in-person and/or phone conversation, audio of the user's VOIP calls, audio of the user's regular user conversation with any of user's contacts, etc. The text component of the communication data may include text of instant messages, such as an SMS, an MMS, etc., chat messages, tweets, status updates on social network, a transcribed phone conversation, a transcription of an in-person conversation, emails, tweets, pictures, comments on various websites, etc.

Text component of a user's communication data may be received by text analytics module 520. Audio component of the user's communication data may be received by voice recognition module 510. In some embodiments, speakers in a nearby user device 504 may pick up the audio component of the user's communication, which takes place without user device 504. Speakers in user device 504 are substantially similar to speakers discussed in relations to FIG. 3.

Voice recognition module 510 processes audio component of the communication data, and identifies user contacts involved in communication with a user. Voice recognition module 510 may also determine proximity of the user contacts from the user device. For example, voice recognition module 510 in a user's television may determine proximity and identity of viewers to the television while they are watching an advertisement. Voice recognition module 510 may be trained based on previous communications of the user with a user contact. The user contact information may be obtained from data source 516. Voice and/or speech pattern may be associated with IP addresses of the user contact device, telephone number of the user contact, user contact information stored on user device 504, or other identifying information associated with a user contact, etc. Once voice recognition module 510 identifies the user contact involved in the communication, it transfers the audio component of the communication data to audio to text module 518.

Audio to text module 518 processes audio component of communication data, and converts it into text using any known speech recognition algorithms, such as, Hidden Markov models, neural networks, etc. Audio to text module 518 then sends the text of the audio component of the communication data to text analytics module 520. Text analytics module 520 may also receive text component of the communication data directly from user device 504.

Text analytics module 520 may process text of communication data, and extract various keywords included in the communication data. For example, a user may be discussing with a friend about a tablet computer. Text analytics module 520 will extract keywords, such as, “tablet”, “computer”, etc. from the discussion above. Text analytics module 520 may use various language processing techniques, for example statistical machine learning techniques, to organize the text obtained from various sources of communication. Text analytics module 520 may filter stop words, such as articles and prepositions, from the text. In some embodiments, text analytics module 520 may only retain words of a certain part of speech, such as, nouns and/or verbs. The remaining words may be reduced to their stem, base, or root form using any stemming algorithm, for example, suffix-stripping algorithms. Additional processing of the text may include correcting spelling errors, identifying synonyms or related words, performing co-reference resolution, and performing relationship extraction.

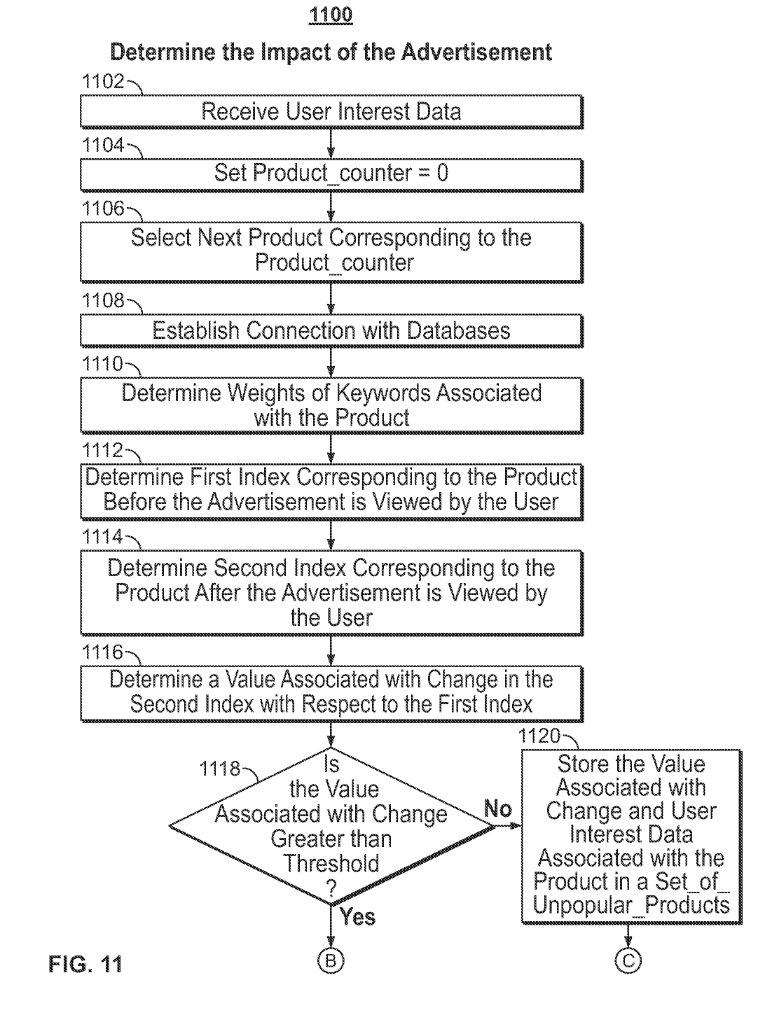

Once words are processed, they may be classified as keywords, counted, and each keyword may be assigned a keyword-count. Keyword-count corresponds to a number of times the keyword is included in the communication data. Text analytics module 520 may use part of process 1000, described in detail in FIG. 10, to determine a keyword-count associated with each keyword. For example, text analytics module 520 may determine that “tablet” is mentioned twenty times in user communication, “computer” is mentioned ten times in user communication, and “soda” is mentioned only once. Text analytics module 520 may transfer various keywords and their respective keyword-count to user interest module 522.

User interest module 522 may use data received from text analytics module 520 to determine user interest. User interest may include a level of a user's interest in various products. Process 1000, described in detail in FIG. 10, may be used by user interest module 522 to determine user interest. Based on keyword-count, user interest module 522 may categorize various keywords according to different levels of user interest. In some embodiments, user interest levels may be normalized to a range within 0 to 100 or any other suitable range. For example, user interest module 522 may determine that the user communication includes keywords associated with tablet computer more frequently than the keywords associated with soda. Therefore, the keyword-count associated with tablet computer will be more than the keyword-count associated with soda. Based on this determination, user interest module 522 may determine that the user is more interested in tablet computer than soda.

User interest module 522 may use various matching algorithms, such as approximate string matching techniques, to determine a match between keywords identified by text analytics module 520 and keywords associated with different products. These matching algorithms may allow for variance in user communication data and the keywords stored in data source 516. Keywords associated with different products may be obtained from data source 516. For example, keywords such as soda, a brand name may be associated with a specific brand of soda. User interest module 522 may compute a matching score for various keywords. For example, “lady” may just indicate a lady or may indicate a ladyfinger. In some embodiments, user interest module 522 may select the keyword with the highest score. User interest module 522 may require the matching score for the keyword to exceed a threshold level. Instead of selecting the keyword with highest score, user interest module 522 may select all the keywords that have a matching score above or below a threshold.

User interest module 522 may further use various algorithms, such as Naïve Bayes classifiers and hierarchical Bayesian models, to determine various products associated with various matching keywords. For example, user interest module 522 may determine keywords, such as soda, famous actor, red, etc., are associated with an advertisement about a brand of soda where the famous actor is wearing red clothes. User interest module 522 may also determine that those keywords are associated with a movie where the famous actor is drinking another brand of soda from a red can. The algorithms use by user interest module 522 may consider the probability that one group of keywords is associated with one product over another.

Other suitable statistical classification methods, such as random forests, Monte Carlo methods, etc., may be used to associate different groups of keywords to different products. In some embodiments, user interest module 522 may select a product with the highest probability of being associated with the most number of keywords included in user communication data. In some embodiments, user interest module 522 may require the highest probability to reach a predetermined threshold. In some embodiments, user interest module 522 may use keywords associated with emotions, such as “love”, “adorable”, “cute”, “repulsive”, “eww”, etc., to determine if a user is interested or disinterested in a product. In some embodiments, user interest module 522 may determine user interest in a product by monitoring user activities. For example, a user may not talk about a brand of soda but still purchase and consume that brand of soda because the user in interested in that brand of soda.

User interest module 522 may use a computerized predictive model to predict, using keyword-count for each keyword associated with a product, a level of user's interest in a product. In some embodiments, the level of user interest in a product may be sum total of keyword-count of all the keywords associated with a product. The predictive model can be trained to classify a product as indicative of a high, low, or any other suitable level of user interest based on the sum total being above or below a threshold.

User interest module 522 may communicate identified keywords, keyword-count, and the level of user interest in various products, herein referred to as user interest data, to impact analysis module 524. Media asset impact monitoring system 502 may receive request from a vendor to determine impact of an advertisement, for example the latest soda advertisement featuring famous actor, on a user of a user device 504. Impact analysis module 524 of media asset impact monitoring system 502 may determine a time when a user viewed the advertisement.

The time may be determined by tracking user activity and logging time when a user views an advertisement. If the advertisement is within on-demand content then impact analysis module 524 may determine the time by tracking when the on-demand content is displayed on a user device. In some embodiments, the time may be determined by a user input on the user device 504. For example, a user may skip an advertisement after viewing it for ten seconds, which may indicate that the user viewed the advertisement. Impact analysis module 524 may also track various advertisement tags to determine the time when user viewed the advertisement. Voice recognition module 510 may also track the time when an advertisement was played on a user device by recognizing the audio of the advertisement. In some embodiments, Internet cookies may be used to track the time. Impact analysis module 524 may use location information from a user device, such as user's cell phone, to determine if the user was in the vicinity of the device on which the advertisement was displayed.

Once impact analysis module 524 determines the time, when the advertisement is viewed, impact analysis module 524 may request user interest data from user interest module 522 for the time before and after the advertisement is viewed. Based on this data, impact analysis module 524 may determine a value of change in keyword-count of various keywords from before user viewed the advertisement to after user viewed the advertisement. In some embodiments, impact analysis module 524 may determine impact of an advertisement based on change in activities of a user after the user viewed the advertisement.

In some embodiments, impact analysis module 524 may determine weights associated with each keyword included in user communication. These weights may indicate the importance of each keyword in determining impact of the advertisement. Different parameters may affect the value of different weights associated with each keyword. Weights used for a specific keyword may be different in different situations. In some embodiments, different weights may be provided by a vendor. For example, a vendor may indicate interest in determining whether a user, after viewing a soda advertisement, started using a specific brand name of soda more in user communication. However, a user may, out of habit, use a keyword “pop” in user communication more instead of the specific brand name of soda. Based on this information and vendor preferences, impact analysis module 524 may assign a very low weight value to the keyword “pop” and a very high weight value to the specific brand name. This system of weights may ensure that certain habits of a user are normalized before determining impact of an advertisement.

In some embodiments, weights may be assigned to different keywords based on user's ethnicity, native language, demographic information, geographic information, user preferences, user social media contacts, etc. Furthermore, weights may be chosen either for one keyword as described above or for a group of keywords included within certain communication data. The group of keywords may be associated with a certain product, which may help impact analysis module 524 to give more importance to certain products over others. Weights may also be chosen based on user location at the time when the communication data is retrieved. For example, a high weight value can be assigned to the communication data retrieved while the user is making a purchase either online or in a store. For a vendor this user communication data may be more important than other user communication data because this data may give actual insights to a user's decision making process. This may also help to determine if a user made a purchase after viewing the advertisement.

In some embodiments, different weights may be assigned depending on the medium of communication. For example, a vendor may be interested only in the communication data obtained from social media and may assign a high weightage to the data from the social media and very low weightage to any other communication data. In some implementations, the impact analysis module 524 may give equal weightage to all the keywords.

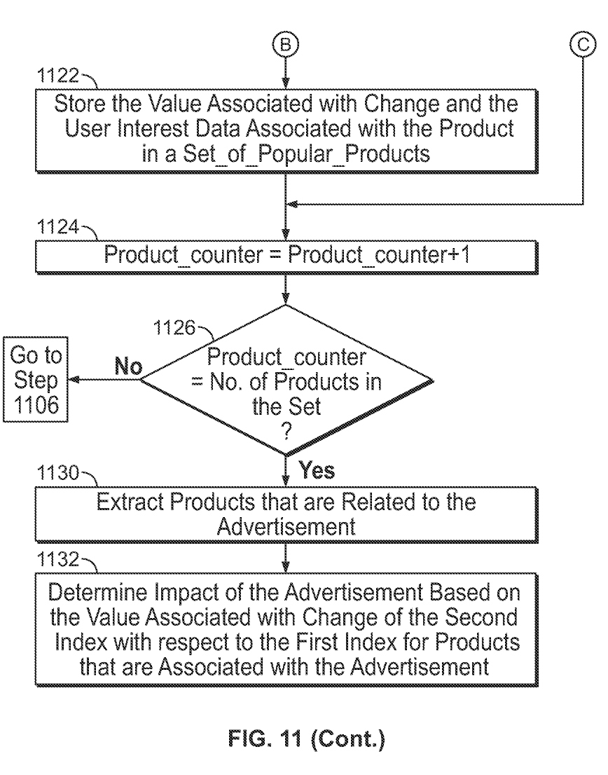

Impact analysis module 524, using process 1100 described in FIG. 11, may determine impact of an advertisement based on weights and user interest data before and after the advertisement is viewed by the user. For example, impact analysis module 524 may determine that the soda advertisement, which features a famous actor, had a big impact on the user because of the increased usage of keywords soda and famous actor from before viewing the advertisement to after viewing the advertisement. In some embodiments, impact analysis module 524 may determine that, even though there is little change in usage of keywords associated with the advertisement, user's purchasing and/or consuming habits are changed after viewing the advertisement. For example, after viewing the advertisement, the user started consuming more soda of that particular brand or started purchasing clothes worn by the famous actor in the advertisement.

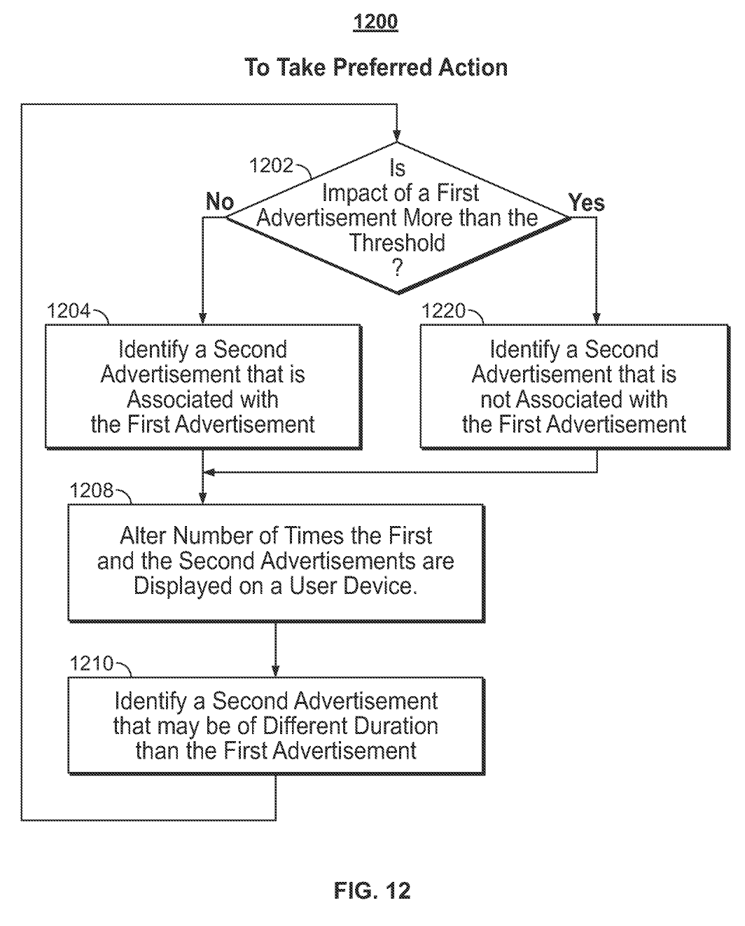

Impact analysis module 524 may normalize impact values to a number between 0 and 100, or any other suitable range, using any of the existing normalization techniques. This normalization may help a vendor to compare the impact of several different advertisements over several different time periods. Once the impact of an advertisement is determined, then the impact analysis module 524 may take a preferred action using process 1200 discussed in detail in FIG. 12. Based on the impact, the preferred action may include selecting a different advertisement to be displayed on the user device.

The elements depicted in FIG. 5 may be combined, rearranged, deleted, performed simultaneously without departing from the scope of this disclosure. In some embodiments, instead of using text analytics module 520 to analyze the communication data, an audio analytics model may analyze the audio component of the communication data directly to identify discussed products without converting the audio into text. In such embodiments, there may be no audio to text module 518. In some embodiments, text analytics module 520 may recognize user contacts instead of voice recognition module 520. Audio to text module 518 may be incorporated into voice recognition module 510. In some embodiments, text analytics module 520 and user interest module 522 may be combined into one module. In some embodiments, voice recognition module 510 may be a part of user device 504. Voice recognition module 520 may recognize user contacts and may only transfer communication data associated with registered user contacts. In some embodiments, blocks of FIG. 4 and FIG. 5 may be swapped or combined. For example, media asset impact monitoring system 502 may be a part of user device 504.

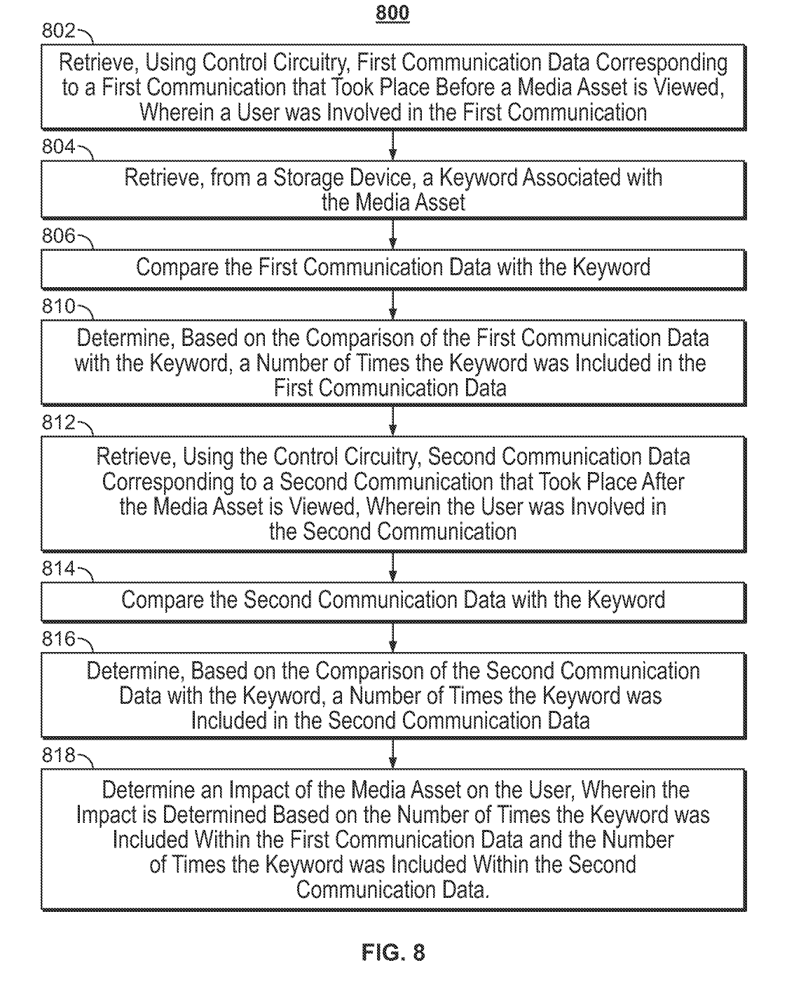

FIG. 6 depicts illustrative display screen 600 showing results of monitoring a user communication in a format requested by a vendor. In some embodiments, a vendor may request to show keyword-count of keywords included in a user's communication before and after the user viewed an advertisement. For example, the vendor may request to generate “top ten keywords by keyword-count”. In some embodiments, the vendor may specify a specific keyword, a group of keywords associated with a specific product, product category, vendor's competitor products, etc. The vendor may further specify a time period for which communication data is analyzed. For example, the vendor may be interested in one month of user communication starting March 25 to April 25. The vendor may also specify types of communication medium. For example, the vendor may indicate interest in viewing keyword-count for online communication, verbal communication, non-verbal communication, etc. In some embodiments, the vendor may request media asset impact monitoring system 502 to compile and present keyword-count for individual users who reside within a geographical region, are within a given age range, of a particular gender, and/or belong to other demographic factors.

As shown in FIG. 6, a vendor may request media asset impact monitoring system 502 to display keyword-count of top-five keywords in user verbal communication one month before and after March 29, 616. Keyword-count 602 is represented on the y-axis and time 604 is represented on the x-axis. In some embodiments, x and y axis may be switched. March 29, 616 may be a date when a vendor released an advertisement. In some embodiments, media impact monitoring system 502 may determine that the user viewed the advertisement on March 29, 616. In this example shown in FIG. 6, the user included, before March 29, 616, the keyword “soda” 100 times 606, “car” 100 times 608, “famous actor” 500 times 610, “smartphone” 2000 times 612, and “website” 1000 times 614. After March 29, 616, the user used the keyword “soda” 2000 times 618, “car” 100 times 620, “famous actor” 2000 times 622, “smartphone” 2000 times 624, and “website” 500 times 626.

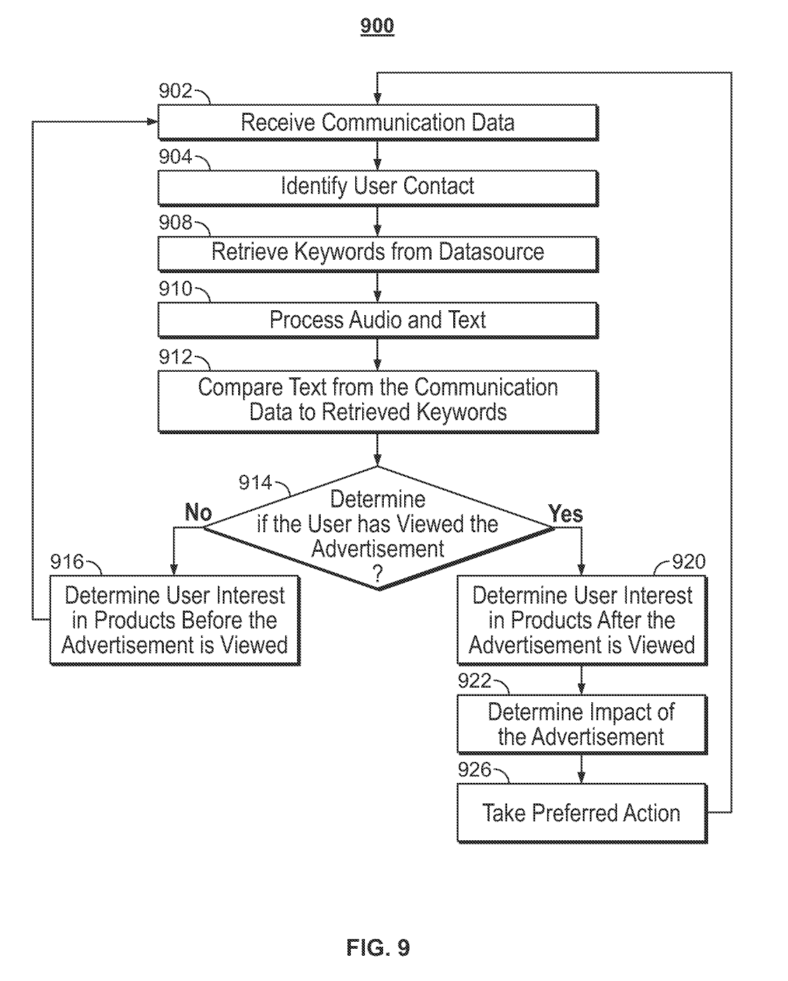

FIG. 7 depicts illustrative display screen 700 showing a graph of impact of an advertisement 714 on a user of a user device. As discussed in FIG. 5, media asset impact monitoring system 502 may determine impact of the advertisement on the user. Impact analysis module 524 may determine the impact of the advertisement using process 1100 discussed in detail in FIG. 11. A graph of the impact of a soda advertisement 702 on a user with time 704 is shown in FIG. 7. Media asset impact monitoring system 502 may determine that the user viewed the soda advertisement on March 29, 708. Before March 29, 708 impact of the soda advertisement 714 is nearly zero, since the user has not viewed the advertisement. Impact of the soda advertisement 714 starts to vary after the user viewed the advertisement on March 29, 708.

A vendor may get additional insights from the variation of the impact values with time. For example, as shown in FIG. 7, the impact 714 peaked on March 30, 712, and effectively remained the same till April 15, 706 after which the impact starts to decrease. The vendor may determine maximum variation in impact 710 with time. In some embodiments, the vendor may find this analysis useful to devise effective advertising strategies, such as, to release a second advertisement when the impact of the first advertisement is starting to decrease.

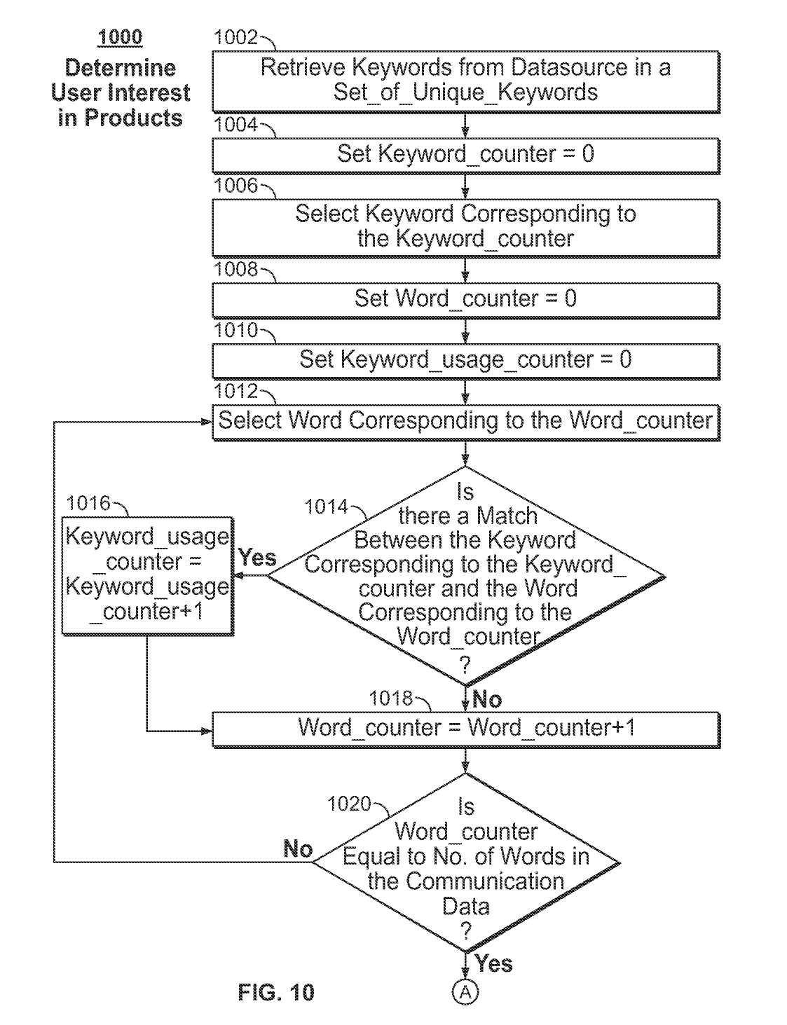

FIG. 8 depicts illustrative process 800 that may be implemented by media asset impact monitoring system 502 for automatically determining impact of an advertisement on a user of a user device. In some embodiments, the impact is based on keyword-count of various keywords that were included in user communication before and after the user viewed the advertisement. At step 802, media asset impact monitoring system 502 may retrieve first communication data corresponding to a first communication that took place before a media asset is viewed, wherein a user was involved in the first communication. Media asset impact monitoring system 502 may receive the first communication data using either voice recognition module 510 or text analytics module 520. The first communication data may correspond to the user communication before the user viewed an advertisement. In some embodiments, media asset impact monitoring system 502 may use the first communication data to determine user interest in various products before the user viewed the advertisement.

At step 804, media asset impact monitoring system 502 may retrieve, from data source 516, a plurality of keywords associated with the media asset. The keywords may also be associated with various products that may not be related to the advertisement. At step 806, media asset impact monitoring system 502 may compare the first communication data with the plurality of keywords retrieved in step 804. This comparison may allow media asset impact monitoring system 502 to identify products that a user is discussing, before viewing the advertisement.

At step 810, media asset impact monitoring system 502 may determine, based on the comparison of the first communication data with the plurality of keywords, a number of times at least one of the plurality of keywords was included in the first communication data. At this step, media impact monitoring system 502 may determine keyword-count of various keywords included in user communication before a user viewed the advertisement. Keyword-count may be used to determine user interest in various products that may or may not be associated with the advertisement. User interest in various products may be determined using process 1000 discussed in detail in FIG. 10.

At step 812, media asset impact monitoring system 502 may retrieve, using control circuitry, second communication data corresponding to a second communication that took place after the media asset is viewed, wherein the user was involved in the second communication. Media asset impact monitoring system 502 may receive second communication data using either voice recognition module 510 or text analytics module 520. The second communication data may correspond to user communication after the user viewed an advertisement. In some embodiments, media asset impact monitoring system 502 may use the second communication data to determine user interest in various products after the user viewed the advertisement. In some embodiments, media impact monitoring system 502 may determine a time when the user viewed the advertisement. In some embodiments, a vendor may provide the time when the user viewed the advertisement.

At step 814, media asset impact monitoring system 502 may compare second communication data with the plurality of keywords retrieved from data source 516 in step 804. This comparison may allow media asset impact monitoring system 502 to identify different products that a user is discussing after viewing the advertisement. These products may or may not be associated with the advertisement.

At step 816, media asset impact monitoring system 502 may determine, based on the comparison of second communication data with the plurality of keywords, a number of times at least one of the plurality of keywords was included in the second communication data. At this step, media impact monitoring system 502 may determine a keyword-count of various keywords included in user communication after the user viewed the advertisement. The keyword-count may be used to determine user interest in various products that may or may not be associated with the advertisement. User interest in various products may be determined using process 1000 discussed in detail in FIG. 10.

At step 818, media asset impact monitoring system 502 may determine impact of the media asset on the user. The impact may be based on the number of times at least one of the plurality of keywords was included within the first communication data and on the number of times at least one of the plurality of keywords was included within the second communication data. The impact may be determined using process 1100 discussed in detail in FIG. 11.

The steps discussed in relation to FIG. 8 can be deleted, rearranged, combined, performed simultaneously, etc. without departing from the scope of this disclosure. For example, in some embodiments, media asset impact monitoring system 502 may simultaneously compare the first and the second communication data with the plurality of keywords retrieved from data source 516. In some embodiments, media asset impact monitoring system 502 may retrieve the plurality of keywords before retrieving the first and the second communication data.

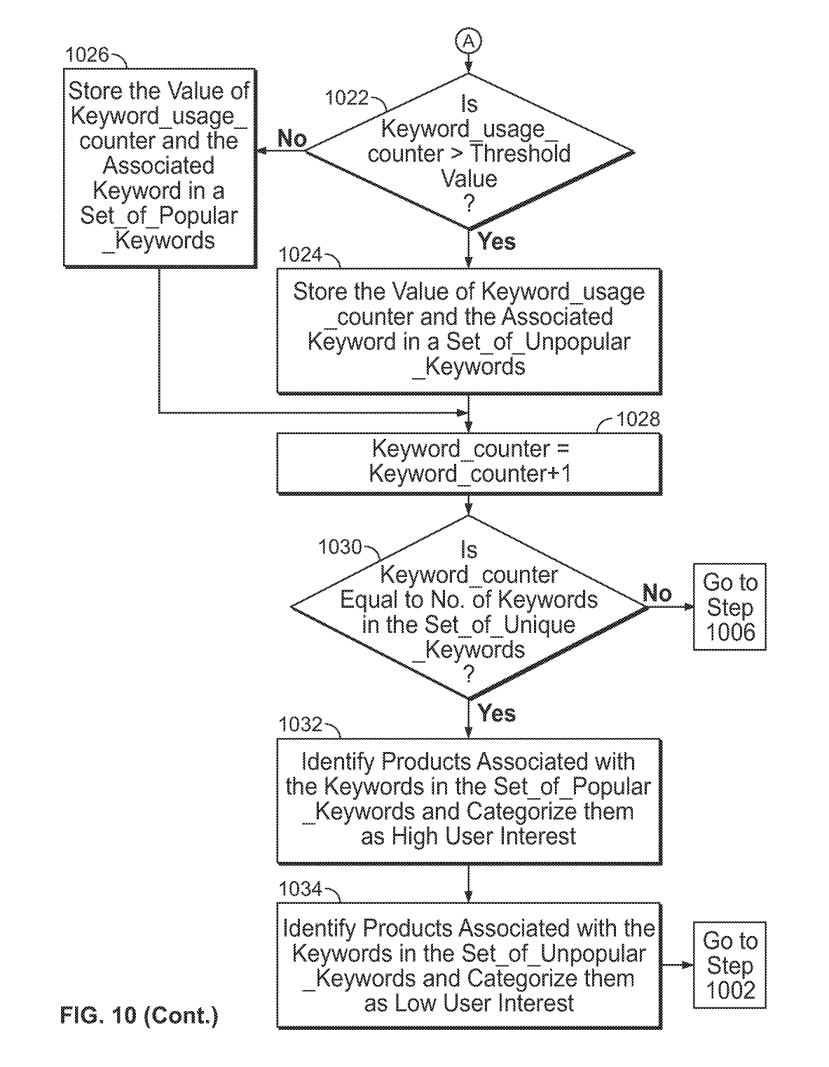

FIG. 9 depicts illustrative process 900 that may be implemented by media asset impact monitoring system 502 for automatically determining impact of an advertisement on a user of a user device. The impact may be based on monitoring keywords included in the user's communication before and after the user views the advertisement. At step 902, media asset impact monitoring system 502 may receive user communication data through voice recognition module 510 or text analytics module 520.

At step 904, media asset impact monitoring system 502 may use various methods discussed in relation to FIG. 5 to identify user contact involved in communication with a user of a user device. In some embodiments, media asset impact monitoring system 502 may determine if the user contacts are not registered. Media asset impact monitoring system 502 may ignore communication data from unregistered user contacts and may only monitor communication data from registered users and user contacts.

At step 908, media asset impact monitoring system 502 may retrieve keywords from data source 516. The keywords may or may not be associated with an advertisement. At step 910, media asset impact monitoring system 502 may process audio and text component of user communication data received in step 902. Text analytics module 520 may analyze the processed communication data to identify keywords included in the communication data. Text analytics module 520 may further determine keyword-count of various keywords included in the communication data. In some embodiments, keyword-count may be determined by using process 1000 as discussed in detail in FIG. 10.

At step 912, media asset impact monitoring system 502 may compare the processed communication data, from step 910, to the keywords retrieved from data source 516 in step 908. This comparison may allow media asset impact monitoring system 502 to identify different products being discussed by a user. Various methods involved in comparing and grouping keywords may be substantially similar to the methods discussed in relation to FIG. 5.

At step 914, media impact monitoring system 502 may determine whether the user has viewed the advertisement. Media impact monitoring system 502 may also determine the exact time, location, and specific user device using which the user has viewed the advertisement. This information may be later used to determine if an advertisement in one medium, such as social media, is producing more impact on the user than the same advertisement in another medium, such as television. Such information may allow a vendor to suitably allocate marketing resources.

If, at step 914, media asset impact monitoring system 502 determines that the user has not viewed the advertisement then it may proceed to step 916. At step 916, media asset impact monitoring system 502 may request user interest module 522 to determine user interest in various products. User interest module 522 may determine user interest in various products, before the advertisement is viewed, using process 1000 discussed in detail in FIG. 10. Media asset impact monitoring system 502 may store user interest data in user profile. After step 916, media asset impact monitoring system 502 may continue to step 902 and keep monitoring the user's communication.

If, at step 914, media asset impact monitoring system 502 determines that the user has viewed the advertisement then it may proceed to step 920. At step 920, media asset impact monitoring system 502 requests user interest module 522 to determine user interest in various products after the user viewed the advertisement. User interest module 522 may determine user interest in various products, after the advertisement is viewed, using process 1000 discussed in detail in FIG. 10. User interest module 522 may store user interest data with appropriate time information. This mechanism of storing information may allow user interest module 522 to access user interest data associated with any time, present or past.

At step 922, media asset impact monitoring system 502 may determine impact of the advertisement on the user using process 1100 discussed in detail in FIG. 11. Media asset impact monitoring system 502 may store user interest data in user profile. At step 926, media asset impact monitoring system 502 may take a preferred action based on the impact of the advertisement determined in step 922. The preferred action may be taken using process 1200 discussed in detail in FIG. 12. After step 926, media asset impact monitoring system 502 may continue to monitor a user's communication, and keep storing user interest data. In some embodiments, media asset impact monitoring system 502 may only monitor user communication for a period of time specified by a vendor.

The steps discussed in relation to FIG. 9 can be deleted, rearranged, combined, performed simultaneously, etc. without departing from the scope of this disclosure. For example, in some embodiments, media asset impact monitoring system 502 may simultaneously perform steps 908 and 910. In some embodiments, media asset impact monitoring system 502 may perform step 914 before 908. Process 900 discussed above may be used by media asset impact monitoring system 502 to determine the impact of an advertisement campaign that may include more than one advertisement.

FIG. 10 is an illustrative process 1000 that may be implemented by media asset impact monitoring system 502 for automatically determining user interest based on keyword-count of keywords that are included in a user's communication. Process 1000 is a detailed description of step 916 and step 920 of FIG. 9. At step 1002, user interest module 522 may retrieve various keywords associated with various products from data source 516. A vendor using media asset impact monitoring system 502 may provide additional keywords related to specific products associated with the vendor that may not be present in the commercial product database 424.

At step 1004, user interest module 522 may collect all unique keywords, obtained from data source 516, in Set_of_Unique_Keywords, and start a counter, such as keyword_counter, from an initial value, for example, one. These keywords may be arranged in any order, and total size of Set_of_Unique_Keywords may correspond to unique keywords present in data source 516. The value of keyword_counter, at any time, may refer to a unique keyword in the Set_of_Unique_Keywords. Changing the value of keyword_counter may mean referring to a different keyword in the set.

At step 1006, user interest module 522 may select the keyword corresponding to the value of the keyword_counter. For example, when the value of the keyword_counter is one, user interest module 522 may select the first keyword in the Set_of_Unique_Keywords. At step 1008, user interest module 522 may initialize a second counter, such as word_counter, to an initial value. Word_counter may correspond to the number of unique words identified by text analytics module 520 in user communication data. The number of words in user communication data may be identified using substantially similar methods as discussed in FIG. 5.

At step 1010, user interest module 522 may initialize a third counter, such as Keyword_usage_counter, to an initial value. Keyword_usage_counter may correspond to keyword-count of a specific keyword in the user communication data. For example, if Keyword_usage_counter equals 5 then it may mean that a specific keyword is mentioned 5 times in the user communication data. At step 1012, the keyword referred to by the keyword_counter may be compared to the keyword referred to by the word_counter. The methods used for keyword comparison may be substantially similar to the methods discussed in FIG. 5.

At step 1014, user interest module 522 may determine if there is a match between two keywords. As discussed earlier, in relation to FIG. 5, the two keywords may be considered a match if their matching score is above a threshold. At step 1016, if there is a match between the two keywords, then Keyword_usage_counter is incremented by 1, before proceeding to step 1018. Increasing Keyword_usage_counter by 1 may indicate that a particular keyword referred to by the keyword_counter is identified one time in the user communication data. At step 1018, if there is no match between the two keywords, then the word_counter is incremented by 1 indicating that user interest module 522 is ready to compare the next keyword in the communication data to the keyword referred to by the keyword_counter.

At step 1020, user interest module 522 may determine if the current value of word_counter is equal to the total number of words identified in the user communication data. If the current value of word_counter is not equal to the total number of words, then user interest module 522 may go back to step 1012 and repeat the process. If the current value of word_counter is equal to the total number of words, then it may indicate that user interest module 522 has compared all the keywords present in the communication data to the keyword referred to by the keyword_counter, and may proceed to step 1022.

At step 1022, user interest module 522 may compare the current value of Keyword_usage_counter to a threshold. As discussed above, the value of Keyword_usage_counter may indicate keyword-count of a specific keyword referred to by the current value of keyword_counter. The threshold may be based on user or vendor preferences. For example, the vendor may only be interested in keywords that are repeated more than three times in a communication, then the threshold value may be three. In some embodiments, the threshold may be a computer generated number based on user profile. If the current value of Keyword_usage_counter is less than the threshold, then, at step 1026, user interest module 522 may store the keyword and its corresponding keyword-count in a Set_of_Unpopular_Keywords.

If the current value of Keyword_usage_counter is more than the threshold, then, at step 1024, user interest module 522 may store the keyword and its corresponding keyword-count in a Set_of_Popular_Keywords. Set_of_Popular_Keywords and Set_of_Unpopular_Keywords may be used by user interest module 522 at a later step to determine a level of user interest in various products associated with keywords present in these two sets. At step 1028, user interest module 522 may increment current value of keyword_counter by one, and go back to step 1006 to compare the next keyword in the Set_of_Unique_Keywords.

At step 1030, user interest module 522 may determine if the current value of keyword_counter is equal to the number of keywords present in Set_of_Unique_Keywords. If the current value of keyword_counter is less than the number of keywords present in Set_of_Unique_Keywords, then user interest module 522 may go back to the step 1006 to repeat the process for the next keyword. If the value of keyword_counter is equal to the number of keywords present in Set_of_Unique_Keywords, then user interest module 522 may proceed to step 1032.

At step 1032, user interest module 522 may identify products associated with keywords present in Set_of_Popular_Keywords. User interest module 522 may further categorize above identified products as high user interest. These products may be of high interest to a user because the keyword-count for these keywords is higher than a threshold. This may mean that the user is including these keywords in user communication more than a threshold level, and may be highly interested in the products associated with these keywords. For example, this step may determine that the user is interested in cars and tablet computer because the keyword-count for keywords associated with these products is higher than a threshold.

At step 1034, user interest module 522 may identify products associated with keywords present in Set_of_Unpopular_Keywords. Use interest module 522 may categorize these products as low user interest. These products may be of low interest to a user because keyword-count of these keywords is lower than a threshold. This may mean that the user is not including these keywords in user communication more than a threshold level, and may be uninterested in the products associated with these keywords. For example, this step may determine that the user is uninterested in bicycles and a desktop computer because the keyword-count for keywords associated with these products is lower than a threshold. The methods used by user interest module 522 for identifying products associated with various keywords, in step 1032 and 1034, may be substantially similar to the methods discussed in relation to FIG. 5.

After step 1034, user interest module 522 may repeat the whole process 1000 again for new set of user communication data. The steps discussed in relation to FIG. 10 can be deleted, rearranged, combined, performed simultaneously, etc. without departing from the scope of this disclosure. For example, user interest module 522 may simultaneously perform steps 1032 and 1034. In some embodiments, user interest module 522 may perform step 1010 before 1008.

FIG. 11 depicts illustrative process 1100 that may be implemented by media asset impact monitoring system 502 for automatically determining impact of an advertisement on a user of a user device before and after the user viewed the advertisement. Process 1100 is a detailed process used in step 922 of FIG. 9. At step 1102, impact analysis module 524 may receive user interest data from user interest module 522. User interest data may be for both, before and after the user viewed the advertisement. For example, user interest data may include data from Set_of_Popular_Keywords (step 1032) and/or Set_of_Unpopular_Keywords (step 1034), discussed in FIG. 10, for before and after the user viewed the advertisement. In some embodiments, impact analysis module 524 may receive data associated to the products that a user is discussing irrespective of user's interest.

At step 1104, impact analysis module 524 may initiate a counter, for example product_counter, to an initial value. Maximum value of the product_counter may correspond to the total number of unique products that a user is discussing, for both before and after the user viewed the advertisement. For example, before viewing the advertisement, the user may be discussing a brand of car and a brand of tablet computer. After viewing the advertisement, the user may be discussing a brand of car, a brand of soda, and a brand of tablet computer. In this example, the maximum value of the product_counter may be three corresponding to three unique products the user is discussing i.e., a brand of car, a brand of soda, and a brand of tablet computer. In some embodiments, impact analysis module 524 may only determine impact of an advertisement on a user's interest in a specific product.

At step 1106, impact analysis module 524 may select a product corresponding to the current value of product_counter. At step 1108, impact analysis module 524 may establish a connection with data source 516 to access information that may be helpful in determining weights for keywords associated with the product referred to by product_counter. For example, the information may be received from a vendor or may be included in the user's profile.

At step 1110, using information from data source 516, impact analysis module 524 may determine weights for keywords associated with the product referred to by product_counter. The weights may be determined by methods that are substantially similar to the methods discussed in FIG. 5.

At step 1112, impact analysis module 524 may determine a first index, for the product referred to by product_counter, before the user viewed the advertisement. The first index may be a mathematical function, such as summation, based on keyword-count and weights of the keywords associated with the product. For example, before viewing the advertisement, the user may be discussing a brand of car. Keywords associated with a brand of car may be “brand name” with keyword-count=1 and weight=4, “color” with keyword-count=3 and weight=1. In this example, the first index for the brand of car may be calculated as follows:

First index=keyword-count*weight for “brand name”+keyword-count*weight for “color”=1*4+3*1=7

At step 1114, impact analysis module 524 may determine a second index, for the product referred to by the product_counter, after the user viewed the advertisement. The second index may be a mathematical function, such as summation, based on keyword-count and weights of the keywords associated with the product. For example, after viewing the advertisement, the user may be discussing a brand of car. Keywords associated with a brand of car may be “brand name” with keyword-count=9 and weight=4, “color” with keyword-count=7 and weight=1. In this example, the second index for the brand of car may be calculated as follows:

Second index=keyword-count*weight for “brand name”+keyword-count*weight for “color”=9*4+7*1=43

Impact analysis module 524 may use some other mathematical function to calculate the first and the second index without departing from the scope of this disclosure. At step 1116, impact analysis module 524 may determine a value associated with change in the second index with respect to the first index of the product referred to by the product_counter. The value associated with change may be any mathematical manipulation, for example difference, of the first and the second index. In the example discussed above, the value associated with change of the second index with respect to the first index for the brand of car may be 43−7=36. In some embodiments, the values of change may be normalized to a number between 0 and 100, or any other suitable range, using any of the existing normalization techniques.

At step 1118, impact analysis module 524 may determine if the value associated with change corresponding to the selected product is more than a threshold. The threshold may be defined by the vendor, or it may be a computer generated number. This determination may be used by impact analysis module 524 to separate products that the user is discussing, either more or less, after viewing the advertisement. In some embodiments, the value associated with change may be an absolute value.

If, at step 1118, impact analysis module 524 determines that the value associated with change is less than the threshold, then it may proceed to step 1120. If, at step 1118, impact analysis module 524 determines that the value associated with change is more than the threshold, then it may proceed to step 1122. At step 1120, impact analysis module 524 may store the product and its associated data in Set_of_Unpopular_Products, and proceed to step 1124. At step 1122, impact analysis module 524 may store the product and its associated data in Set_of_Popular_Products, and proceed to step 1124.

After analyzing the value associated with change in a product's indexes, at step 1124, impact analysis module 524 may increment product_counter by 1 to select the next product. At step 1126, impact analysis module 524 may determine whether the current value of product_counter is equal to the maximum value. If impact analysis module 524 determines that the value of product_counter is less than the maximum value, then it may go back to step 1106. If impact analysis module 524 determines that the value of product_counter is equal to the maximum value, then it may go to step 1130. This may indicate that impact analysis module 524 has analyzed all the products that a user was discussing before and after viewing the advertisement.

At step 1130, impact analysis module 524 may collect information for the products categorized in Set_of_Unpopular_Products and Set_of_Popular_Products. Impact analysis module 524 may further extract data, such as the value associated with change and user interest data, for the products that may be associated with the advertisement. For example, before viewing the advertisement, the user may be discussing a brand of car, and a brand of tablet computer. After viewing the advertisement, the user may be discussing a brand of car, a brand of soda, and a brand of tablet computer. If the advertisement is about a brand of car, then impact analysis module 524 may extract user interest data associated with the brand of car. If the advertisement is about a brand of soda, then impact analysis module 524 may extract user interest data associated with the brand of soda. If the advertisement is about a brand of car and a brand of soda, then impact analysis module 524 may extract user interest data associated with the brand of car and the brand of soda. User interest data, in the above example, may be for both, before and after the user viewed the advertisement. Impact analysis module 524 may use methods substantially similar to the methods discussed in relation to FIG. 5 to determine products associated with an advertisement.

At step 1132, impact analysis module 524 may determine impact of the advertisement. Impact of the advertisement may be a mathematical function, for example summation, of the value associated with change of the second index with respect to the first index for products that may be associated with the advertisement. For example, before viewing the advertisement, the user may be discussing a brand of car, and a brand of tablet computer. After viewing the advertisement, the user may be discussing a brand of car, a brand of soda, and a brand of tablet computer. If the advertisement is about a brand of car and a brand of soda, then the impact of the advertisement may be the sum of the value associated with change of the second index with respect to the first index for the brand of car and the brand of soda. In this example, the value associated with change of the second index with respect to the first index for the brand of car may be 30, for the brand of soda may be 20, and for the brand of tablet computer may be 10. However, since the advertisement is about a brand of car and a brand of soda, the impact of the advertisement may be 30+20=50.

If a user did not discuss any of the products associated with the advertisement, even though the user may be discussing other products, the impact of the advertisement may be zero. Once impact analysis module 524 determines the impact of the advertisement then media asset impact monitoring system 502 may take a preferred action, as discussed in FIG. 12, based on the impact of the advertisement. The steps discussed in relation to FIG. 11 can be deleted, rearranged, combined, performed simultaneously, etc. without departing from the scope of this disclosure. For example, in some embodiments, impact analysis module 524 may simultaneously perform steps 1112 and 1114.

FIG. 12 depicts illustrative process 1200 that may be implemented by media asset impact monitoring system 502 for automatically taking a preferred action based on the impact of an advertisement on a user. Process 1200 is a detailed description of step 926 of FIG. 9. Before step 1202, media asset impact monitoring system 502 may receive the impact of the advertisement, determined at step 1132 of FIG. 11, from impact analysis module 524. At step 1202, media asset impact monitoring system 502 may compare the impact of the advertisement to a threshold. In some embodiments, the threshold may be vendor specified, or a computer generated number. If the impact of the advertisement is less than the threshold, then media asset impact monitoring system 502 may proceed to step 1204. If the impact of the advertisement is more than the threshold, then media asset impact monitoring system 502 may proceed to step 1220.

At step 1204, media asset impact monitoring system 502 may identify a second advertisement that may be associated with the first advertisement. In some cases, an advertisement has low impact because the user may not enjoy content of the advertisement. For example, the content may include an actor, which the user may not like. In some embodiments, the content of the advertisement may involve a sport, such as baseball, which the user may not enjoy. For example, an energy drink advertisement may show, that after taking the energy drink, performance of a baseball player improved. However, even though the user may be interested in the energy drink, this advertisement may have a low impact, because the user immediately skipped the advertisement after seeing baseball. In this example, media asset impact monitoring system 502 may identify a second advertisement associated with the same brand of energy drink that does not include baseball.

In some embodiments, media asset impact monitoring system 502 may identify, from the user interest data, various products of high user interest. For example, based on user interest data, media asset impact monitoring system 502 may determine that the user is interested in adventure sports. Therefore, in order to improve the impact of an energy drink advertisement, media asset impact monitoring system 502 may identify a second advertisement involving adventure sports. In some embodiments, media asset impact monitoring system 502 may access user profile to identify a second advertisement that is associated with user preferences. For example, if the user likes sports cars, then media asset impact monitoring system 502 may select an energy drink advertisement that is associated with sports cars.

If media asset impact monitoring system 502 determines that the impact of the advertisement is more than a threshold, then it may proceed to step 1220. In some cases, if the impact is higher than the threshold, then it may indicate that the user is already influenced by the advertisement, and showing the same advertisement to the user may be waste of marketing resources. Therefore, at step 1220, media asset impact monitoring system 502 may determine a second advertisement that is not associated with the first advertisement. For example, if the impact of a soda advertisement is higher than the threshold, then media asset impact monitoring system 502 may select an advertisement about a cookie that is not associated with the soda advertisement. In some embodiments, the second and the first advertisement may be belong to the same brand or company.

At step 1208, media asset impact monitoring system 502 may alter number of times the advertisement is displayed on a user device. In some cases, an advertisement has low impact because the user viewed the advertisement only once. For example, the user viewed the advertisement while rushing for work, and did not pay attention to it. Therefore, media asset impact monitoring system 502 may try to improve the impact of the advertisement by increasing the number of times the advertisement is displayed on the user device. This may increase the probability that the user views the advertisement multiple number of times, and may be able to attract the user's attention.

In some cases, an advertisement has low impact, because the user spends most time on Internet, but viewed the advertisement on television and forgot about it. In such cases, media asset impact monitoring system 502 may redirect the advertisements from television to Internet, and vice versa. This strategy is equally applicable for redirecting advertisements from one website to another, one television channel to another, one user device to another, one communication medium to another, etc.

In some embodiments, even if the impact of the advertisement is higher than the threshold, it could be higher if the user viewed the advertisement on a different medium. For example, a user may view a soda advertisement on television with an impact value of 20. But, since the user spends most time on Internet, the user may forget about the soda advertisement. Therefore, media asset impact monitoring system 502 may increase the impact of the soda advertisement, from 20 to 50, by diverting the advertisement from television to Internet.

At step 1210, media asset impact monitoring system 502 may select a second advertisement that may be of different duration than the first advertisement. In some cases, an advertisement has low impact because the user only viewed first five seconds of a one minute advertisement, and pressed skip. Therefore, media asset impact monitoring system 502 may select a second advertisement that is of a shorter duration than the first advertisement. In some embodiments, even if the impact of the advertisement is higher than the threshold, it may be even higher if the user viewed the advertisement of a shorter duration. For example, a user may have only viewed first five seconds, out of a total of sixty seconds, of a soda advertisement that has an impact value of 20. But, media asset impact monitoring system 502 may increase the impact of the soda advertisement, from 20 to 50, by selecting a second soda advertisement with a shorter duration.

It should be understood that the methods and systems described above are equally applicable to determine the impact of a media asset other than an advertisement such as a movie, video clip, etc. For example, media asset impact monitoring system 502 may determine the time when a user viewed a movie, video clip, video game, etc., or listened a song, podcast, audiobook, etc. on a user device. Media asset impact monitoring system 502 may monitor user communication both before and after the user viewed the media asset. Text analytics module 520 may access data source 516 for keywords associated with the media asset, such as songs, actors, product names, etc. Text analytics module 520 may use this information to process user communication data, and identify keyword-count of the keywords included in user communication data.

User interest module 522 may determine user interest in a particular media asset. Impact analysis module 524 may use the data from user interest module 522 to determine impact of the media asset. For example, the impact of the media asset may be high if, after viewing the media asset, a user is discussing more about products associated with the media asset. Based on the impact of the media asset, the media asset impact monitoring system 502 may take a preferred action such as recommending another movie, song, audiobook, etc. to the user.

It should be understood that the above steps of the flow diagrams of FIGS. 8, 9, 10, 11 and 12 may be deleted, rearranged, combined, performed simultaneously, etc. without departing from the scope of this disclosure. The above-described embodiments of the present disclosure are presented for purposes of illustration, and not of limitation.

1. A method for determining impact of a media asset, the method comprising:
retrieving, using control circuitry, first communication data corresponding to a first communication that took place before a media asset is viewed and second communication data corresponding to a second communication that took place after the media asset is viewed, wherein a user was involved in the first and the second communications;
retrieving, from a storage device, a keyword associated with the media asset;
comparing the first and the second communication data with the keyword;
determining, based on the comparison, a number of times the keyword was included in the first and the second communication data; and
determining an impact of the media asset on the user based on the number of times the keyword was included within the first communication data and the number of times the keyword was included within the second communication data.

2. The method of claim 1, wherein determining the impact comprises:
determining a value, wherein the value is associated with change between the number of times the keyword was included within the first communication data and the number of times the keyword was included within the second communication data; and
adding the value to a previously determined value associated with another keyword, wherein the another keyword is associated with the media asset.

3. The method of claim 2 further comprising:
determining a product associated with the keyword for which the value exceeds a threshold.

4. The method of claim 3, wherein the media asset is a first media asset, further comprising:
determining a second media asset associated with the product.

5. The method of claim 1 further comprising:
identifying a weight associated with the keyword;
determining a first index based on the weight and the number of times the keyword was included within the first communication data;
determining a second index based on the weight and the number of times the keyword was included within the second communication data; and
determining the impact of the media asset on the user of the user device based on the first index and the second index.

6. The method of claim 5, wherein determining the impact comprises:
determining a value, wherein the value is associated with change between the second index and the first index; and
adding the value to a previously determined value associated with another keyword, wherein the another keyword is associated with the media asset.

7. The method of claim 1, wherein the media asset is an advertisement, a program, a program segment, Internet content, a video clip, an image, an application, or a game; and
wherein at least one of the first and the second communication data includes at least one of an email message, an SMS, an MMS, a transcribed phone conversation, a chat message, a tweet, a status update on social network, and a transcription of an in-person conversation.

8. The method of claim 1, wherein the media asset is a first media asset, further comprising:
comparing the impact of the first media asset to a threshold;
when the impact exceeds the threshold, selecting a second media asset that is unrelated to the first media asset; and
when the impact is lower than the threshold, selecting the second media asset that is related to the first media asset.

9. The method of claim 1, wherein the media asset is a first media asset, further comprising:
comparing the impact of the first media asset to a threshold;
selecting, when the impact is lower than the threshold, a second media asset that is related to the first media asset;
determining a first number of times the first media asset was viewed by the user; and
generating for display the second media asset for a second number of times based on the first number of times the first media asset was viewed by the user.

10. The method of claim 1, wherein the media asset is a first media asset, further comprising:
comparing the impact of the first media asset to a threshold;
selecting, when the impact is lower than the threshold, a second media asset that is related to the first media asset;
determining a first user device on which the user viewed the first media asset; and
generating for display the second media asset on a second user device based on the first user device on which the user viewed the first media asset.

11. A system for determining impact of a media asset, the system comprising:
control circuitry configured to:
retrieve first communication data corresponding to a first communication that took place before a media asset is viewed and second communication data corresponding to a second communication that took place after the media asset is viewed, wherein a user was involved in the first and the second communications;
retrieve, from a storage device, a keyword associated with the media asset;
compare the first and the second communication data with the keyword;
determine, based on the comparison, a number of times the keyword was included in the first and the second communication data; and
determine an impact of the media asset on the user based on the number of times the keyword was included within the first communication data and the number of times the keyword was included within the second communication data.

12. The system of claim 11, wherein the control circuitry is configured to determine the impact by:
determining a value, wherein the value is associated with change between the number of times the keyword was included within the first communication data and the number of times the keyword was included within the second communication data; and
adding the value to a previously determined value associated with another keyword, wherein the another keyword is associated with the media asset.

13. The system of claim 12, wherein the control circuitry is further configured to:
determine a product associated with the keyword for which the value exceeds a threshold.

14. The system of claim 13, wherein the media asset is a first media asset, the control circuitry is further configured to:
determine a second media asset associated with the product.

15. The system of claim 11, wherein the control circuitry is further configured to:
identify a weight associated with the keyword;
determine a first index based on the weight and the number of times the keyword was included within the first communication data;
determine a second index based on the weight and the number of times the keyword was included within the second communication data; and
determine the impact of the media asset on the user of the user device based on the first index and the second index.

16. The system of claim 15, wherein the control circuitry is configured to determine the impact by:
determining a value, wherein the value is associated with change between the second index and the first index; and
adding the value to a previously determined value associated with another keyword, wherein the another keyword is associated with the media asset.

17. The system of claim 11, wherein the media asset is an advertisement, a program, a program segment, Internet content, a video clip, an image, an application, or a game; and
wherein at least one of the first and the second communication data includes at least one of an email message, an SMS, an MMS, a transcribed phone conversation, a chat message, a tweet, a status update on social network, and a transcription of an in-person conversation.

18. The system of claim 11, wherein the media asset is a first media asset, the control circuitry is further configured to:
compare the impact of the first media asset to a threshold;
when the impact exceeds the threshold, select a second media asset that is unrelated to the first media asset; and
when the impact is lower than the threshold, select the second media asset that is related to the first media asset.

19. The system of claim 11, wherein the media asset is a first media asset, the control circuitry is further configured to:
compare the impact of the first media asset to a threshold;
select, when the impact is lower than the threshold, a second media asset that is related to the first media asset;
determine a first number of times the first media asset was viewed by the user; and
generate for display the second media asset for a second number of times based on the first number of times the first media asset was viewed by the user.

20. The system of claim 11, wherein the media asset is a first media asset, the control circuitry is further configured to:
compare the impact of the first media asset to a threshold;
select, when the impact is lower than the threshold, a second media asset that is related to the first media asset;
determine a first user device on which the user viewed the first media asset; and
generate for display the second media asset on a second user device based on the first user device on which the user viewed the first media asset.

21-40. (canceled)
